(19) United States
(12) Patent Application Publication
(10) Pub. No.: US 2018/0130124 A1
(43) Pub. Date: May 10, 2018

(54) METHOD FOR PRODUCT SERVICE SYSTEM CLASSIFICATION AND SERVICE TRANSFORMATION

(71) Applicant: National Tsing Hua University, Hsinchu City (TW)

(72) Inventors: Ming-Chuan Chiu, Hsinchu City (TW); Chih-Yuan Chu, Taichung City (TW)

(73) Assignee: National Tsing Hua University, Hsinchu City (TW)

(21) Appl. No.: 15/438,110

(22) Filed: Feb. 21, 2017

(30) Foreign Application Priority Data
Nov. 10, 2016 (TW) 105136572

(51) Int. Cl. G06Q 30/06

(52) U.S. Cl. CPC G06Q 30/0645

(57) ABSTRACT

A method for product service system classification and service transformation is provided. In the method, analysis data of multiple product service systems (PSSs) is collected and accordingly multiple condition attributes of the PSSs are defined and used to establish a classification decision table. Then, reducts of the condition attributes are induced from the classification decision table through a rough set theory algorithm and accordingly multiple candidate decision rules are generated. The candidate decision rules are validated by using the analysis data to generate final decision rules. The final decision rules are applied to determine a current type of the PSS of a target firm. Core competences of the target film are analyzed to determine a recommend type of the PSS for the future. Finally, a transformation recommendation for the service of the target firm is provided according to differences between the condition attributes of the recommend type and the current type.

### CROSS-REFERENCE TO RELATED APPLICATION

This application claims the priority benefit of Taiwan application serial no. 105136572, filed on Nov. 10, 2016. The entirety of the above-mentioned patent application is hereby incorporated by reference herein and made a part of this specification.

### BACKGROUND

### Technical Field

The present disclosure is related to a product service system, and more particularly, to a method for product service system classification and service transformation.

### Description of Related Art

Product service system (PSS) is an emerging industry concept combining tangible products and intangible services, and supporting the public network. The concept has been widely investigated and discussed in each field in these ten years. PSS may satisfy various customer demands, reduces environmental impacts made by industries, improves commercial value of the product services, and further reconstruct the core competences of firms.

Because of the said benefits, industry and academia have devoted effort in innovations of the PSS. In which, design methodology of PSS, integrating products and service design techniques, and practical application of PSS are included.

However, few studies have focused on the PSS classification types. Most studies have been largely subjective and qualitative, but these studies are far from a variety of current emerging industries. Therefore, the past discussions and discoveries are not available for the present PSS environment anymore.

### SUMMARY

The invention provides a method for PSS classification and service transformation. By providing a complete and quantized PSS classification, a firm may be assisted to understand its suitable type of PSS and the critical attribute needed to be emphasized on for transformation.

The method for PSS classification and service transformation of the invention is adapted to an electronic apparatus having a processor. This method collects analysis data of multiple PSSs, accordingly defines multiple condition attributes of the PSSs, and establishes a classification decision table using the condition attributes. Then, reducts of the condition attributes are induced from the classification decision table through a rough set theory (RST) algorithm and accordingly multiple candidate decision rules are generated. The final decision rules are applied to determine a current type of the PSS of a target firm. Core competences of the target firm is analyzed to determine a recommend type of the PSS for the future. Finally, a transformation recommendation for the service of the target firm is provided according to differences between the condition attributes of the recommend type and the current type.

In an embodiment of the invention, the step of defining the condition attributes of the PSSs and establishing the classification decision table using the condition attributes includes screening multiple critical attributes from the condition attributes by an expert group assembled by multiple knowledge fields, and establishing the classification decision table by using the critical attributes.

In an embodiment of the invention, the step of defining the condition attributes of the PSSs includes determining whether each condition attribute is continuous; and discretizing the condition attribute if the condition attribute is not continuous.

In an embodiment of the invention, the step of inducing the reducts of the condition attributes through the RST algorithm, and accordingly generating the candidate decision rules of the classifications includes defining multiple decision rules by using the condition attributes, and calculating a support of each decision rule, and comparing the support to a support threshold. If the support of the decision rule is greater than the support threshold, selecting the decision rule as the candidate decision rule, and if the support of the decision rule is not greater than the support threshold, excluding the decision rule.

In an embodiment of the invention, the step of inducing the reducts of the condition attributes through the RST algorithm, and accordingly generating the candidate decision rules of the classifications includes respectively defining the decision rules having the classifications belonging to a product-oriented type, a use-oriented type, a result-oriented type, and a platform-oriented type.

In an embodiment of the invention, the condition attribute of the decision rule having the classification belonging to the platform-oriented type comprises an intangible product form, and a product ownership not belonging to a manufacture, a service provider and a customer.

In an embodiment of the invention, the step of validating the candidate decision rules by using the analysis data to generate the final decision rules includes calculating a confidence and a lift of each candidate decision rule, and respectively comparing the confidence and the lift to a confidence threshold and a lift threshold. If the calculated confidence and the lift are greater than the confidence threshold and the lift threshold respectively, confirming the candidate decision rule as being the final decision rule.

In an embodiment of the invention, the step of analyzing the core competences of the target firm includes analyzing the core competences of the target firm by adopting a hierarchical structure of resources, capabilities and competences.

In an embodiment of the invention, the step of analyzing the core competences of the target firm further includes evaluating collectiveness, uniqueness and strategic flexibility to ensure the core competences of the target firm.

In an embodiment of the invention, the step of analyzing core competences of the target firm to determine the recommend type of the PSS of the target firm for the future includes analyzing an industry background, a position in a value chain, and the core competences of the target film by an expert group assembled by multiple knowledge fields, to determine the recommend type of the PSS.

Based on the above, the method for PSS classification and service transformation of the invention establishes the classification decision table by using the existing analysis data of the PSS, and induces the reducts of the attributes through the RST, so as to obtain multiple classifications of the PSS and the decision rules of each classification. By applying the decision rules to analysis of the PSS of the target firm, a firm may be assisted to understand the current type of PSS and the transformation direction for the future, and a suitable transformation recommendation may be provided.

In order to make the aforementioned and other features and advantages of the disclosure comprehensible, several exemplary embodiments accompanied with figures are described in detail below.

It should be understood, however, that this Summary may not contain all of the aspects and embodiments of the present disclosure, is not meant to be limiting or restrictive in any manner, and that the disclosure as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a block diagram of an electronic apparatus according to an embodiment of the invention.

FIG. 2 illustrates a flowchart of a method for PSS classification and service transformation according to an embodiment of the invention.

FIG. 3 illustrates a classification decision table according to an embodiment of the invention.

FIG. 4 illustrates a decision rule table according to an embodiment of the invention.

FIGS. 5A and 5B illustrate the decision rule tables translated into the IF-THEN descriptions according to an embodiment of the invention.

FIG. 6 illustrates a schematic diagram of analyzing the core competences of the car rental company C by adopting the hierarchical structure according to an embodiment of the invention.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

The invention extends classifications of product service system (PSS) by using rough set theory (RST), and establishes a complete and quantized structure of PSS classification. Through the structure, different classifications and the decision rules of each classification may be induced from the current PSS cases. The invention further provides a transformation process of the PSS by analyzing the core competences of a firm and the type of the current PSS, so that the firm may be assisted to understand the suitable type of the PSS and the critical attributes needed to be emphasized on when the firm performs PSS transformation from old business models.

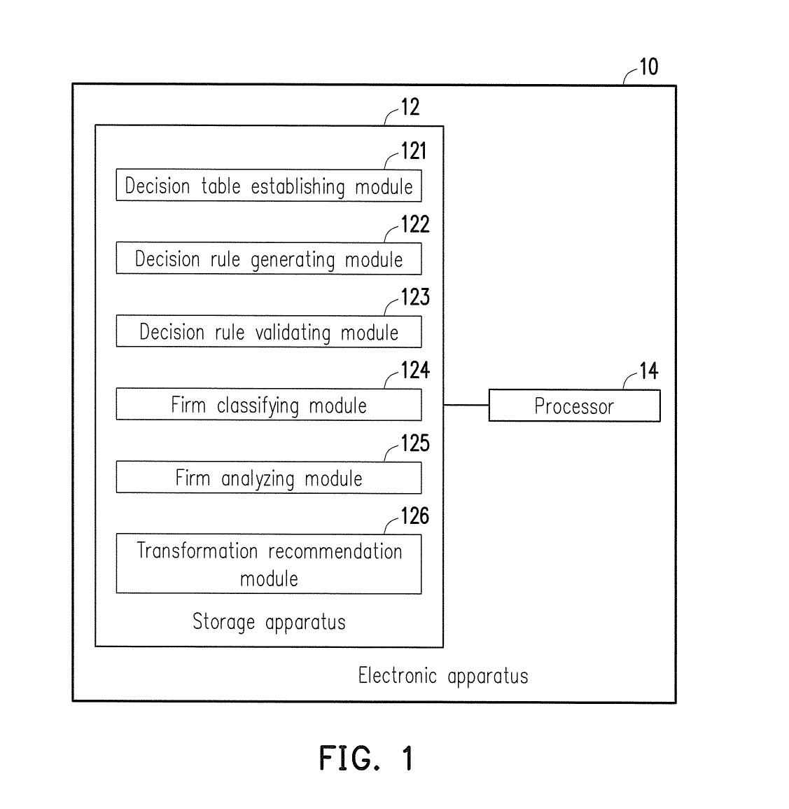

FIG. 1 illustrates a block diagram of an electronic apparatus according to an embodiment of the invention. Please refer to FIG. 1, the electronic apparatus 10 is, for example, a computing apparatus with calculation capabilities such as a file server, a database server, an application server, a workstation or a personal computer, in which a storage apparatus 12 and a processor 14 are included, and the functions thereof are respectively described in the following.

The storage apparatus 12 may be any type of fixed or removable random access memory (RAM), read-only memory (ROM), flash memory, or the similar devices or the combination of said devices. In the present embodiment, the storage apparatus 12 is configured to store a decision table establishing module 121, a decision rule generating module 122, a decision rule validating module 123, a firm classifying module 124, a firm analyzing module 125, and a transformation recommendation module 126. These modules are, for example, programs stored in the storage apparatus 12.

The processor 14 is, for example, a central processing unit (CPU), or other general or specific programmable microprocessor, digital signal processor (DSP), programmable controller, application specific integrated circuits (ASIC), programmable logic device (PLD), or other similar devices or a combination of the said devices. The processor 14 is connected to the storage apparatus 12 and may load the program of the decision table establishing module 121, the decision rule generating module 122, the decision rule validating module 123, the firm classifying module 124, the firm analyzing module 125 and the transformation recommendation module 126 from the storage apparatus 12, so as to perform the method for PSS classification and service transformation of the invention.

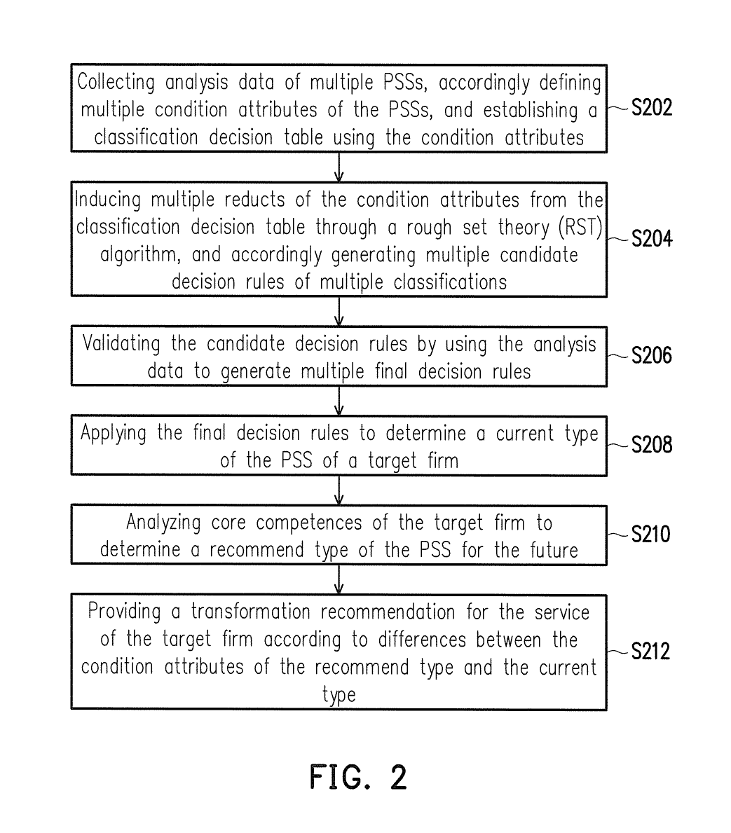

FIG. 2 illustrates a flowchart of a method for PSS classification and service transformation according to an embodiment of the invention. Please refer to FIG. 2, the method of the present embodiment is adapted to the electronic apparatus 10 of FIG. 1. Detailed steps of the method for PSS classification and service transformation are described in the following accompanied with the elements of the electronic apparatus 10.

First, in step S202, the processor 14 may execute the decision table establishing module 121, to collect analysis data of multiple PSSs, accordingly define multiple condition attributes of the PSSs, and establish a classification decision table using the condition attributes (S202). In the initial stage of the present embodiment, the processor 14 selects the condition attributes according to the collected analysis data of PSS of the films. The decision table establishing module 121 may, for example, fill all or part of the collected analysis data into corresponding entries of the classification decision table according to the condition attributes, so as to establish the classification decision table completely.

It is noted that, in one embodiment, the decision table establishing module 121 may, for example, further screen multiple critical attributes from the condition attributes defined by an expert group assembled by multiple knowledge fields, and establish the classification decision table by merely using the critical attributes. On the other hand, based on the limitation that only discrete data can be processed by the RST, the decision table establishing module 121 may, for example, determine whether each of the selected condition attribute is continuous when defining the condition attributes. If the condition attribute is not continuous, the decision table establishing module 121 may further discretize the data of the condition attribute for applying it in the subsequent calculations.

The condition attributes screened by the decision table establishing module 121 may be classified into three phases: product, service and monetary, of the Table 1 shown below.

TABLE 1

| Phase | Condition attribute | Numerical definition |
|---|---|---|
| Product | Product form | Tangible: 0 |
| | | Intangible: 1 |
| | Product size | N/A: 0 |
| | | Small: 1 |
| | | Medium: 2 |
| | | Large: 3 |
| | Product weight | N/A: 0 |
| | | Light: 1 |
| | | Medium: 2 |
| | | Heavy: 3 |
| Service | Product/Service | Customer: 0 |
| | ownership | Manufacturer/Service provider: 1 |
| | | Other: 2 |
| | Service type | Maintenance/Consultancy: 0 |
| | | Rental and leasing: 1 |
| | | Integrated solution: 2 |
| Monetary | Purchase price | Low price level: 0 |
| | | Medium price level: 1 |
| | | High price level: 2 |
| | Payment method | Pay for product: 0 |
| | | By usage: 1 |
| | | By contract: 2 |
| | | By commission/Advertisement: 3 |

In detail, the form, size and weight of the product are considered in the product phase. The value of the product form is determined by whether the product is tangible. The value is set as 0 if the product form is tangible, and the value is set as 1 if the product form is intangible. The size and weight of the product are evaluated by comparing the product object with a reference product selected from all objects. The product size is divided into 1 to 3 from small to large, and the product weight is divided into 1 to 3 from light to heavy. If the product form is intangible, the size and weight thereof are both set as 0s (representing N/A).

In the service phase, the product/service ownership indicates the owner position of the product/service. If the customer owns the product/service after transaction, the value is set as 0. If the manufacturer or the service provider retains the ownership of the product/service, the value is set as 1. If neither condition is matched, the value is set as 2. Service type provided by the firm of the PSS is also included in the phase. All service types described herein are classified into the following three types: maintenance/consultancy, rental and leasing, and integrated solution, where the value are set as 0, 1, and 2 respectively.

It is noted that the monetary phase addressing the product purchase price and payment method is crucial in the sorting process, since these factors influence the business model and directly affect the revenue stream of a firm. Accordingly, regarding the product purchase price in the monetary phase, it is divided into three levels of high, medium, and low by grouping the collected related cases. If the price of the product is in the low level, the value is set as 0. If the price of the product is in the medium level, the value is set as 1. If the price of the product is in the high level, the value is set as 2. On the other hand, regarding the payment method in the monetary phase, if a user pays for product directly, the value is set as 0; if the user pays by usage, the value is set as 1; if the user pays by contract, the value is set as 2; if the user pays by commission/advertisement, the value is set as 3.

On the other hand, the PSSs of different films are identified and evaluated according to the value proposition, the products or services, and the way for creating profits of the firms in the present embodiment. These PSSs may be initially classified by the expert group according to the predetermined characteristics. In addition to the three existing PSS classifications (i.e., product-oriented, use-oriented, and result-oriented), the invention provides a new classification of platform-oriented, where the properties and the potential opportunities are discussed in the following.

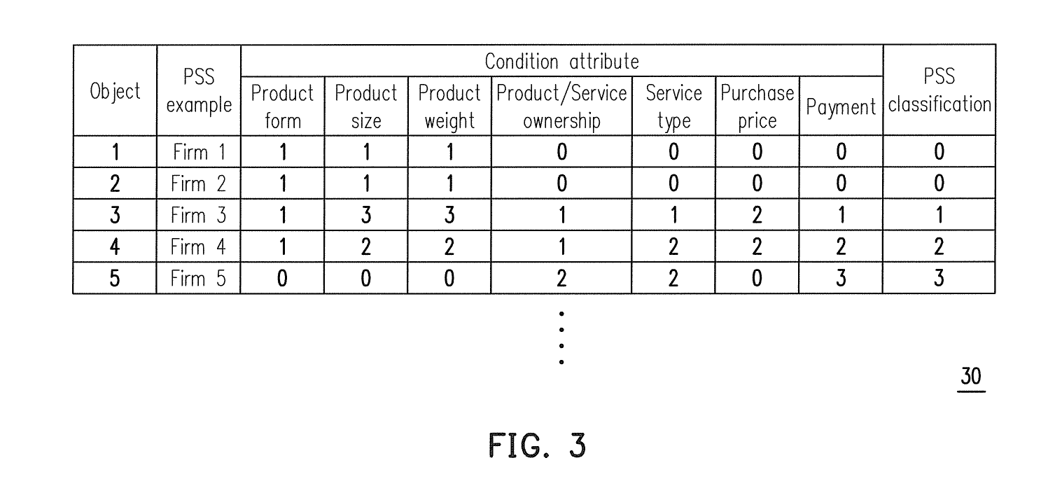

After the object information is confirmed, the classification decision table may be established, as shown in FIG. 3. Please refer to FIG. 3, the classification decision table 30 includes the condition attributes defined according to the examples of the collected PSSs (e.g., PSSs of the firm 1 to 5). By filling the entries of each condition attribute in the classification decision table 30 with the analysis data of the examples of the PSSs according to the numerical definition of Table 1, the establishment of the classification decision table 30 may be completed.

It is noted that, the analysis data of the collected PSSs is divided into a training data set (e.g., 80% randomly selected from all analysis data of the PSSs, but which is not limited herein) and a testing data set (e.g., remaining 20%), then the decision rules are validated through a five-fold cross-validation process.

Referring back to FIG. 2, in step S204, the processor 14 executes the decision rule generating module 122, to induce multiple reducts of the condition attributes from the classification decision table through a rough set theory (RST) algorithm, and to accordingly generate multiple candidate decision rules of multiple classifications.

In detail, the decision rule generating module 122 may, for example, define multiple decision rules by using the said condition attributes, then calculate a support of each decision rule, and compare the support to a predetermined support threshold. If the support of the decision rule is greater than the support threshold, the decision rule generating module 122 may select the decision rule as the candidate decision rule, otherwise, exclude the decision rule.

On the other hand, the decision rule generating module 122 may further categorize the decision rule into one of the PSS classifications of the product-oriented type, the use-oriented type, the result-oriented type, and the platform-oriented type according to the condition attributes included in each decision rule.

In the product-oriented type, if the main service of the firm is maintenance/consultancy, or the ownership of product/service lies with the customers, since the value creation and the customer satisfaction are mainly produced by the product and its ownership, and the revenue of the firm is derived from the product selling, the PSSs having the decision rules of the condition attributes are defined as the product-oriented type.

In the use-oriented type, if the product form is tangible and the ownership lies with the manufacturer or the service provider, it is very likely to be the use-oriented type. Nearly all of the use-oriented type PSSs possess the characteristics of a rental and leasing type. Particularly, if a firm provides a rental and leasing service and its product purchase price is at a high level, the PSS having the decision rules of the condition attributes may be defined as the use-oriented type.

The result-oriented type is an advanced version of the product-oriented type and the use-oriented type. The unique features of this type are that it provides integrated solutions, the purchase price of the product is high since needs of the wide-ranging customer are required to be met, and the payment method are most by a project or a contract. Both tangible and intangible forms of products/services are possible of being the result-oriented type, and therefore the product form, size and weight are relatively insignificant in this classification.

In the platform-oriented type, since the operation of the PSS of this type is simply the intermediary among manufacturers, service providers and the customers, the product form is intangible. According to this intermediary property, product/service ownership does not lie with anyone of the manufacturer, the service provider and the customer. This type of PSS provides an integrated solution for the customers, as the result-oriented type of PSS does. However, there are still some differences. The result-oriented type of PSS, such as a firm providing IT service modularization, provides a personalized integrated solution for a customer's specific purposes based on different background information. On the other hand, the platform-oriented type of PSS provides an integrated personalized solution with a virtual platform that enables numerous interactions between customers and others in the system. Co-creation and collaboration are key points of this type of PSS. This type of PSS maintains its operation based on advertising, commissions, and transaction fees. Customers contribute a portion of its target product/service price to enjoy the convenience of the platform. Crowd funding platforms such as Kickstarter, e-commerce dealer such as eBay and the recent Uber offering the car rental and real-time carpooling are representations of this type of PSS.

The platform-oriented type of PSS is mainly related to IT technologies. The application of website, mobile devices, and wearable devices are the strengths and opportunities of the platform-oriented type of PSS. A large customer base is required to maintain the speed needed for matching customers to service providers. The platform-oriented type firms provide neither products nor services but serve as the intermedia in the value chain providing a bridging activity regarded as another kind of service. These firms are not only service providers but also service demanders.

It should be noted that, in said stage of generating decision rules, the decision rules are at the formation stage and being without input from the expert groups, therefore the decision rules might be premature or inapplicable. Accordingly, in step S206 of the present embodiment, the processor 14 executes the decision rule validating module 123, to validate the candidate decision rules generated by the decision rule generating module 122 by using the analysis data of the PSS (e.g., data of the test data set), so as to generate multiple final decision rules.

In detail, the decision rule validating module 123 may calculate a confidence and a lift of each candidate decision rule, and compare the confidence and the lift to a predetermined confidence threshold and lift threshold respectively. If the calculated confidence and the lift are greater than the confidence threshold and the lift threshold respectively, the decision rule validating module 123 may confirm the candidate decision rule as being the final decision rule.

For example, in one embodiment, the support threshold θₛ may be set as 0.15 using the tool of the RST, in order to generate the rules for selection by the expert groups. In addition, the confidence threshold θ_{c} and the lift threshold θₗ may be set as 0. 7 and 1 respectively. If the confidence and the lift of the decision rule are greater than these thresholds, the decision rule may be selected as the final decision rule.

In the calculation of the RST in the present embodiment, 267 decision rules may be generated from the decision table 30 of FIG. 3. The induced reducts of all the condition attributes are the product/service ownership, service type, payment methods. That is, these attributes are essential attributes determining the PSS.

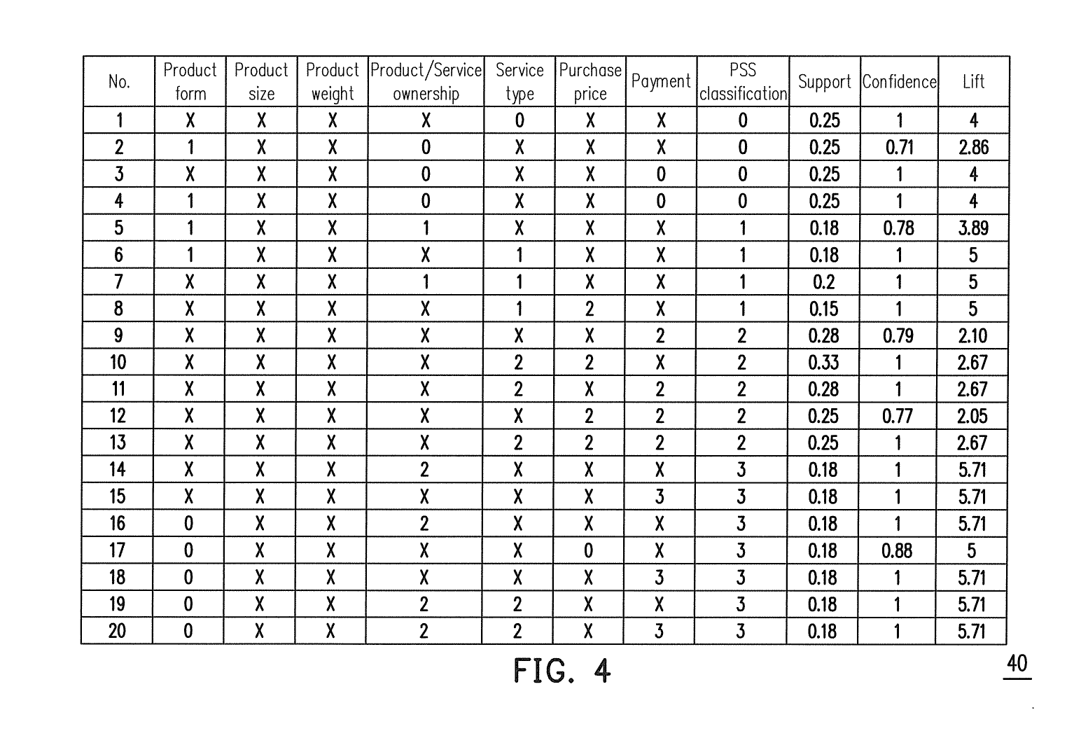

After the five-fold cross-validation process and being validated by the expert group, 20 decision rules may be selected as the final decision rules. The decision rule table 40 of FIG. 4 lists the selected final decision rules of each classification of the PSS. Each decision rule includes at least one condition attribute (the entry filled with x represents that the condition attribute is not included) and a corresponding PSS classification (numbers 0 to 3 represent the product-oriented type, the use-oriented type, the result-oriented type, and the platform-oriented type respectively). Within these 20 decision rules, 4 rules are for the product-oriented PSS, 4 rules are for the use-oriented PSS, 5 rules are for the result-oriented PSS, and 7 rules are for the platform-oriented PSS. The decision rule table 40 also lists the support, confidence and lift of each decision rule satisfying the support threshold (i.e., 0.15), the confidence threshold (i.e., 0. 7) and the lift threshold (i.e., 1) respectively.

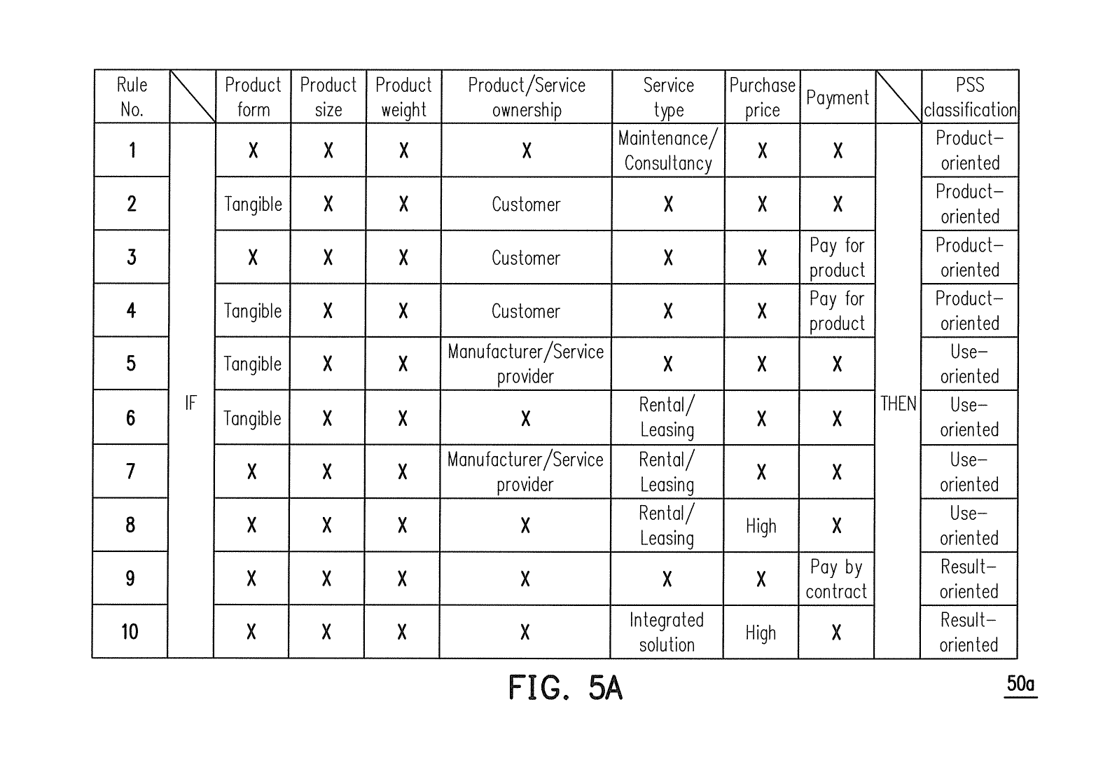

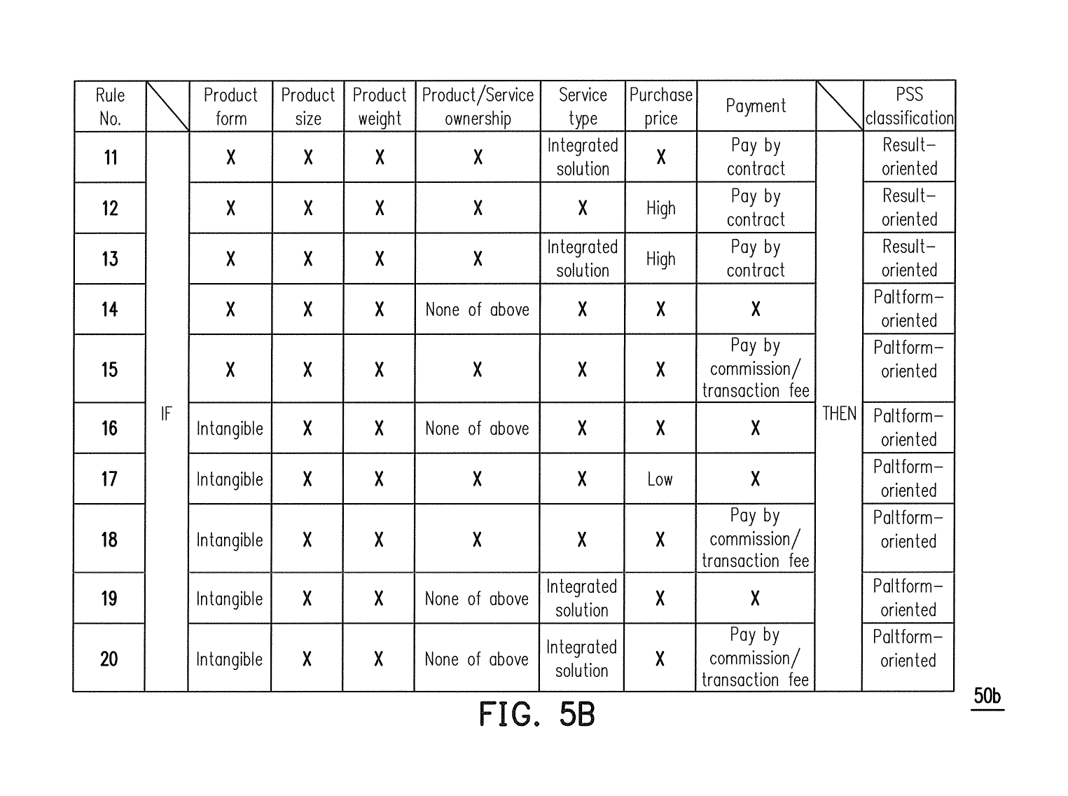

FIGS. 5A and 5B respectively list the decision rule tables 50a and 50b, which translate the final decision rules of each PSS classification of FIG. 4 into the IF-THEN descriptions. The decision rule tables 50a and 50b clearly list the condition attributes and the corresponding PSS classification included in each decision rule.

For example, in rule 1, if the service type of the PSS is maintenance/consultancy, it may be categorized as the product-oriented type. In rule 5, if the product form of the PSS is tangible, and the product/service ownership is manufacturer/service provider, it may be categorized as the use-oriented type. In rule 10, if the service type of the PSS is integrated solution, and the purchase price of the product is high, it may be categorized as the result-oriented type. In rule 16, if the product form of the PSS is intangible, and the product/service ownership is N/A (i.e., not belong to anyone of the manufacturer, the service provider and customer), it may be categorized as the platform-oriented type.

The said final decision rules may be used for evaluating the PSS classification and the transformation direction for the future of the target firm, so as to provide a suitable transformation recommendation.

In detail, referring back to FIG. 2, in step S208, the processor 14 executes the firm classifying module 124, to apply the final decision rules to determine a current type of the PSS of the target firm. For example, if the PSS of a firm satisfies the decision rules 5 to 8 in FIG. 5A, it may be categorized as the use-oriented type.

Then, in step S210, the processor executes the firm analyzing module 124, to analyze core competences of the target firm to determine a recommend type of the PSS for the future. In detail, in one embodiment, the film analyzing module 124 may, for example, analyze the core competences of the target film by adopting the hierarchical structure of resources, capabilities and competences.

It should be noted that, in one embodiment, the firm analyzing module 124 may, for example, further evaluate collectiveness, uniqueness and strategic flexibility of the target firm to ensure the core competences of the target firm.

After evaluating the core competences of the firm, the firm analyzing module 124 may, for example, analyze an industry background, a position in a value chain, and the said core competences of the target film by an expert group assembled by multiple knowledge fields, to determine the recommend type of the PSS.

Finally, in step S212, the processor 14 may operate the transformation recommendation module 126, to provide a transformation recommendation for the service of the target firm according to differences between the condition attributes of the recommend type and the current type. In detail, by consulting the final decision rules generated in step S206 (e.g., the decision rules listed in the decision rule tables 50a and 50b of FIG. 5A and FIG. 5B), the decision rules corresponding to the recommend type may be found. By comparing the decision rules to the decision rules corresponding to the current type of the target firm, the condition attributes needed to be emphasized on during the transformation of the firm may be known clearly.

A transformation of a car rental company C is taken as an example in the following, which illustrates the implementation of the method for PSS classification and service transformation of the embodiment of the invention. First, the products of the car rental company C are tangible trucks, vans, and sedans, the main business is the car rental/leasing service that resolves point-to-point transportation problems by sharing the utilization of products. Based on the nature of the rental/leasing service, product ownership lies with the car rental company C instead of the customer. By introducing the conditions into the said decision rules listed in FIG. 5A and FIG. 5B, it may be determined that the PSS of the car rental company C satisfies the decision rules 5 to 8. Accordingly, the PSS of the car rental company C may be categorized as the use-oriented type.

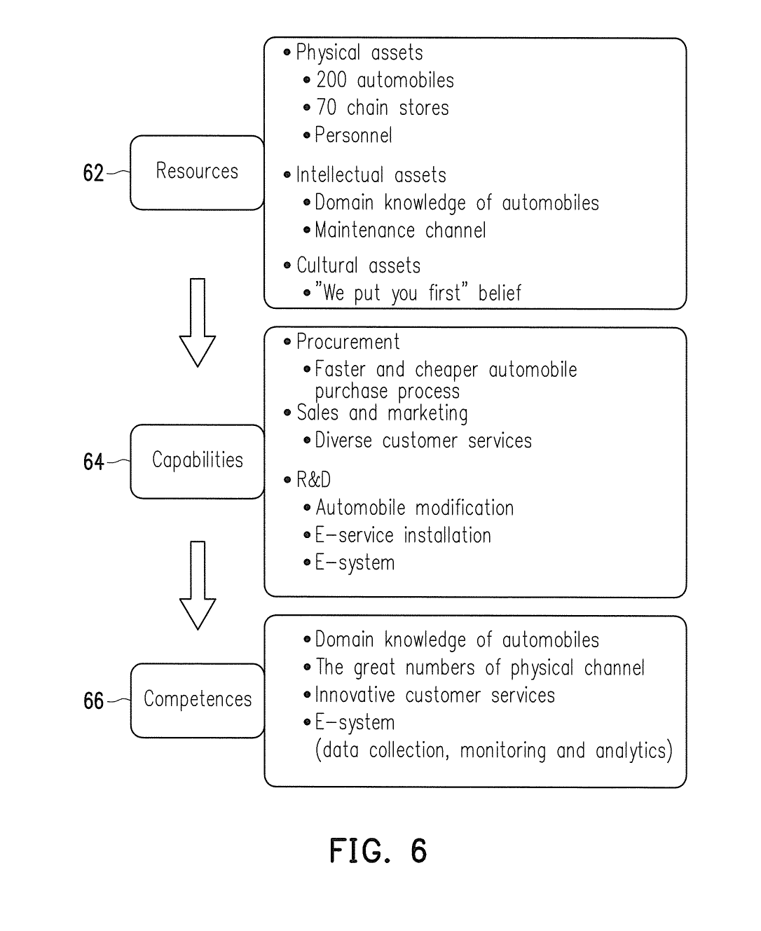

Then, the core competences of the car rental company C may be analyzed by the hierarchical structure of resources, capabilities, and competences. In detail, FIG. 6 illustrates a schematic diagram of analyzing the core competences of the car rental company C by adopting the hierarchical structure according to an embodiment of the invention. Please refer to FIG. 6, the core competences of the car rental company C is evaluated in a sequence of resources 62, capabilities 64, and competences 66 in the present embodiment. In the evaluation of resources 62, the resources of the car rental company C are categorized into physical assets, intellectual assets, and culture assets for evaluation. In the evaluation of capabilities 64, the capabilities of procurement, sales and marketing, and R&D of the car rental company C are analyzed. In the evaluation of competences 66, the fortes of the car rental company C, such as domain knowledge of automobiles, the great numbers of physical channel, innovative customer services, and e-system, are analyzed.

According to the above evaluation result, automobile know-how is the core competences of the car rental company C, especially the domain knowledge of automobiles, the great numbers of physical channel, the innovative customer services, and the e-system.

If the future business target of the car rental company C is focused on short-term rental, and for solving the problem of insufficient number of cars at peak demand time, the platform-oriented type of PSS may be recommended to the car rental company. The car rental company C may be recommended to establish a strategic alliance with other car rental/leasing companies for more agile vehicle management. The car rental company C may make use of its e-system (a core competence) to develop a service platform for short-term rental brokerage service, which may connect customers who need short-term car rental with customers having an idle car. As a result, the risk and cost of oversupply for satisfying customer demand of rental vehicles may be reduced. People interested in providing their cars for extra revenue can register on a website, and the car rental company C can periodically examine the cars' condition using the high density outlets of the car rental company C. Accordingly, the car rental company C may benefit from collecting registry fees and brokerage fees.

In summary, the method for PSS classification and service transformation of the invention defines the condition attributes of the PSSs from the analysis data of the existing PSSs, and further induces the reducts of the condition attributes through the RST algorithm, so as to generate a plurality of decision rules of various classifications according to the induced critical attributes. The decision rules may assist a firm in understanding its suitable type of PSS and the critical attributes needed to be emphasized on in the future when the firm performs PSS transformation from old business models, so as to make use of the core competences thereof to perform service transformation effectively.

It should further be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the disclosure. Further combinations of the above features are also considered to be within the scope of some embodiments of the invention. It will also be appreciated by persons skilled in the art that the invention is not limited to what has been particularly shown and described hereinabove.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for product service system classification and service transformation adapted to an electronic apparatus having a processor, comprising:
collecting analysis data of a plurality of product service systems (PSSs), accordingly defining a plurality of condition attributes of the PSSs, and establishing a classification decision table using the condition attributes;
inducing a plurality of reducts of the condition attributes from the classification decision table through a rough set theory (RST) algorithm, and accordingly generating a plurality of candidate decision rules of a plurality of classifications;
validating the candidate decision rules by using the analysis data to generate a plurality of final decision rules;
applying the final decision rules to determine a current type of the PSS of a target firm;
analyzing core competences of the target firm to determine a recommend type of the PSS of the target firm for the future; and
providing a transformation recommendation for the service of the target firm according to differences between the condition attributes of the recommend type and the current type.

2. The method as claimed in claim 1, wherein the step of defining the condition attributes of the PSSs and establishing the classification decision table using the condition attributes comprises:
screening a plurality of critical attributes from the condition attributes by an expert group assembled by a plurality of knowledge fields, and establishing the classification decision table by using the critical attributes.

3. The method as claimed in claim 1, wherein the step of defining the condition attributes of the PSSs comprises:
determining whether each condition attribute is continuous; and
discretizing the condition attribute if the condition attribute is not continuous.

4. The method as claimed in claim 1, wherein the step of inducing the reducts of the condition attributes through the RST algorithm, and accordingly generating the candidate decision rules of the classifications comprises:
defining a plurality of decision rules by using the condition attributes;
calculating a support of each decision rule, and comparing the support to a support threshold;
if the support of the decision rule is greater than the support threshold, selecting the decision rule as the candidate decision rule; and
if the support of the decision rule is not greater than the support threshold, excluding the decision rule.

5. The method as claimed in claim 4, wherein the step of inducing the reducts of the condition attributes through the RST algorithm, and accordingly generating the candidate decision rules of the classifications comprises:
respectively defining the decision rules having the classifications belonging to a product-oriented type, a use-oriented type, a result-oriented type, and a platform-oriented type.

6. The method as claimed in claim 5, wherein the condition attributes of the decision rules having the classification belonging to the platform-oriented type comprises an intangible product form, and a product ownership not belonging to a manufacture, a service provider and a customer.

7. The method as claimed in claim 1, wherein the step of validating the candidate decision rules by using the analysis data to generate the final decision rules comprises:
calculating a confidence and a lift of each candidate decision rule, and respectively comparing the confidence and the lift to a confidence threshold and a lift threshold; and
if the calculated confidence and the lift are greater than the confidence threshold and the lift threshold respectively, confirming the candidate decision rule as being the final decision rule.

8. The method as claimed in claim 1, wherein the step of analyzing the core competences of the target film comprises:
analyzing the core competences of the target firm by adopting a hierarchical structure of resources, capabilities and competences.

9. The method as claimed in claim 8, wherein the step of analyzing the core competences of the target firm further comprises:
evaluating a collectiveness, a uniqueness and a strategic flexibility of the target firm to ensure the core competences of the target firm.

10. The method as claimed in claim 1, wherein the step of analyzing core competences of the target firm to determine the recommend type of the PSS of the target firm for the future comprises:
analyzing an industry background, a position in a value chain, and the core competences of the target firm by an expert group assembled by a plurality of knowledge fields, to determine the recommend type of the PSS.
